(19) United States
(12) Patent Application Publication
(10) Pub. No.: US 2009/0050698 A1
(43) Pub. Date: Feb. 26, 2009

(54) Sales Tool

(76) Inventors: Jay B. Storey, Andover, KS (US); Steven R. Spatz, Wichita, KS (US)

Correspondence Address: LATHROP & GAGE LC, 2345 GRAND AVENUE, SUITE 2800, KANSAS CITY, MO, 64108, US

(21) Appl. No.: 12/197,081

(22) Filed: Aug. 22, 2008

Related U.S. Application Data
(60) Provisional application No. 60/957,511, filed on Aug. 23, 2007.

(51) Int. Cl. G06F 17/00

(52) U.S. Cl. 235/383; 235/375

(57) ABSTRACT

Disclosed is a computer system for use in a retail store. The store employees are provided with wireless devices. The wireless devices are able to interface with a local area network associated with the store and are able to receive product availability information, e.g., inventory; product detail information; and pricing information anywhere in the store. This enables the salespersons to give a customer inventory and other details regarding a displayed product while remaining by the side of the customer, as well as provide the customer with a printed quote that can be used to generate the embodiment of a ticket at the point of sale

### CROSS-REFERENCE TO RELATED APPLICATIONS

This application claims the benefit of U.S. Provisional Application No. 60/957,511 filed Aug. 23, 2007, the disclosure of which is incorporated herein by reference.

### BACKGROUND

1. Field of the Invention

The disclosed embodiments, in general, relate to the use of computing systems in stores for assisting with sales. More specifically, the disclosed embodiments relate to the use of wireless devices to assist with the sales processes.

2. Description of the Related Art

Many kinds of stores, e.g., furniture sellers, appliance dealers, and many others display only a portion of the inventory available. Further, the displayed inventory may be for show only, and unavailable for purchase. Thus, availability of the product is not readily available, as compared to products in which all, or substantially all inventory appears in the sales area. Because of this, the sales person may have to take numerous trips away from the consumer to and from a personal computer on the store's Local Area Network (LAN) to determine whether the product is available in stock. As any salesperson knows, any time the salesman is away from the consumer is not only frustrating for the consumer, but also reduces the effectiveness of the sales person.

Other than inventory, other information may be lacking at the point of product display as well. For example, a sales floor display will include a particular kind of item, e.g., a sofa, but there will be numerous options available, e.g., color patterns, sizes. For example, the consumer may want to know if the particular item would fit in a desired location in their home. Getting product dimensions will thus again cause the salesperson to stray from the consumer in order to get, e.g., precise product dimensions.

Another aspect the conventional sales process that is time consuming and interferes with the salesperson/customer relationship is that of building a customer ticket. Once a customer makes a selection of a displayed product or products on the showroom floor, the salesman normally leaves the customer at the display to generate a ticket at a personal computer on the LAN. This may be a significant distance from the product the customer is looking at. Again, this salesman/customer separation is detrimental to sales.

### SUMMARY

In embodiments, a method is disclosed in which a computer system is used to sell a product. The method involves providing a product which is labeled with an electronically-readable product identifier; electronically receiving the product identifier using a handheld computing device; accessing (i) local product information regarding the product from a local database which is included in a local area network, and (ii) remote product information regarding the product from a remote database; and then availing the local product information and the remote product information to the handheld computing device such that the local product information and the remote product information are able to be displayed on the handheld computing device for the purpose of enabling a salesperson to remain with a customer while obtaining the product information. In some embodiments the product is an item of furniture.

In other embodiments, the process involves including the product identifier in a bar code format on or about the product, and then adapting the hand-held computing device to read the bar code format.

In terms of the information provided, embodiments include product dimensions in one or both of the local product information and the remote product information. Profit margin information in one of the local product information and the remote product information is also included in embodiments. Some embodiments even include delivery-time estimations in the local product information or the remote (e.g. Mfg's system) product information. Other embodiments include inventory information in the local product information conveyed. Still other embodiments include inventory information in the remote product information. Order status information is included in one of the local product information and the remote product information in embodiments. Estimated delivery time information is also included in one of the local product information and the remote product information.

Further, in embodiments, a ticket-building process is operable on the handheld computing device. The ticket-building process enables the salesperson to build an electronic ticket. This electronic ticket includes at least one product selection made by the customer, and enables data-transfer or capture of the electronic ticket to the local area network for payment management purposes, e.g., so that a cashier can ring up the ticket based on the selection made from the handheld. In embodiments the displayed product is added to the electronic ticket by taking a reading of an affixed product identifier. In other embodiments the ticket-building process is adapted to accommodate a plurality of co pending electronic tickets on the handheld computing device. A unique identification number, e.g., a home phone number, is received from the customer, and then associated with the electronic ticket with the unique identification number (e.g. customer account number). In other embodiments, the ticket building process enables the generation of a second electronic ticket on the handheld computing device whereas the first ticket can be distinguished from the second ticket based on the unique identification numbers received from the distinct customers.

### BRIEF DESCRIPTION OF THE DRAWINGS

FIG. 1 illustrates a system diagram for a computing environment in which one embodiment of the disclosed processes could be performed.

FIG. 2 illustrates a process flow diagram for one embodiment of the sales tool.

FIG. 3 illustrates one embodiment for a bar-code including label used in one embodiment.

FIGS. 4-9 show handheld screen shot displaying various information disclosures for various embodiments.

### DETAILED DESCRIPTION

Where products are displayed, the disclosed systems and methods enable a salesperson to remain by the side of a customer and obtain information regarding the product, e.g., inventory forecasting information, ticket building, pricing information, so that the sales process is not interfered with. These objectives are achieved by providing the sales person with a hand held device which is able to interface with the businesses computing systems to obtain the information needed instantly and without the need to leave the customer to obtain the information from a PC. Additionally, the overall system enables interfacing not only with the facilities LAN to obtain local inventory and other information, but additionally, the sales person is able to forecast inventory in the future by receiving information from a remote manufacturer. Obtaining this, and other information would normally have taken considerable time away from the customer in the past. Now, however, the salesman can perform the functions by the customer's side.

The process avoids these problems using the systems and methods described below. Unless otherwise specified, any terms used herein should be interpreted broadly and liberally to the extent allowed by the art and the meaning of the words offered in context.

As one skilled in the art will appreciate, the present invention may be embodied as, among other things: a method, system, or computer-program product. Accordingly, the present invention may take the form of a hardware embodiment, a software embodiment, or an embodiment combining software and hardware. In a preferred embodiment, the present invention takes the form of a computer-program product that includes computer-useable instructions embodied on a computer-readable medium.

Computer-readable media include both volatile and nonvolatile media, removable and nonremovable media, and contemplates media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. An exemplary modulated data signal includes a carrier wave or other transport mechanism. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

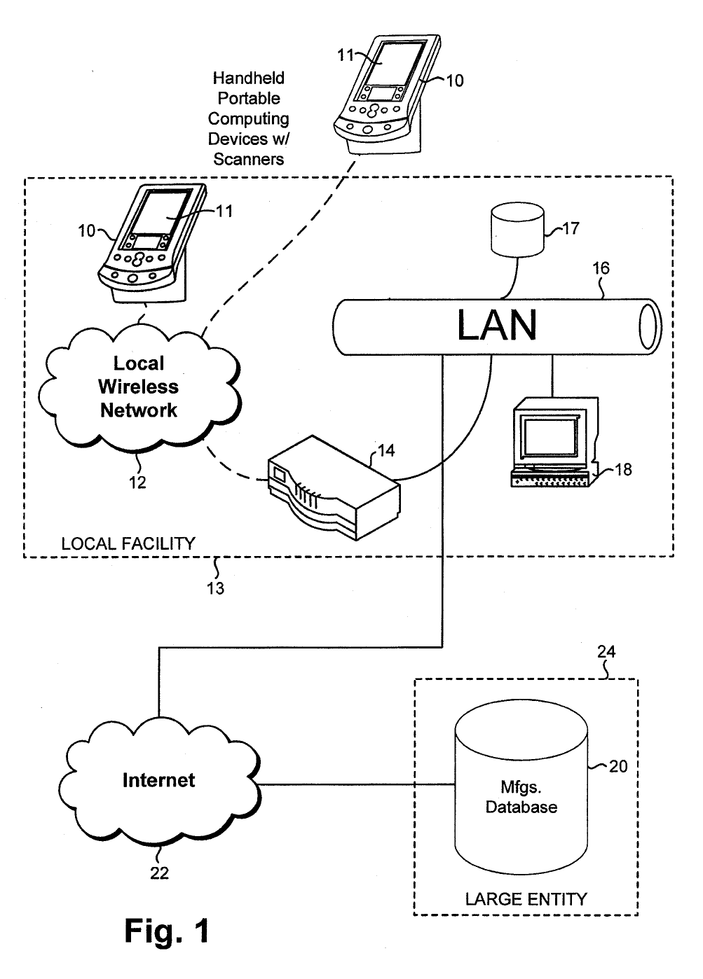

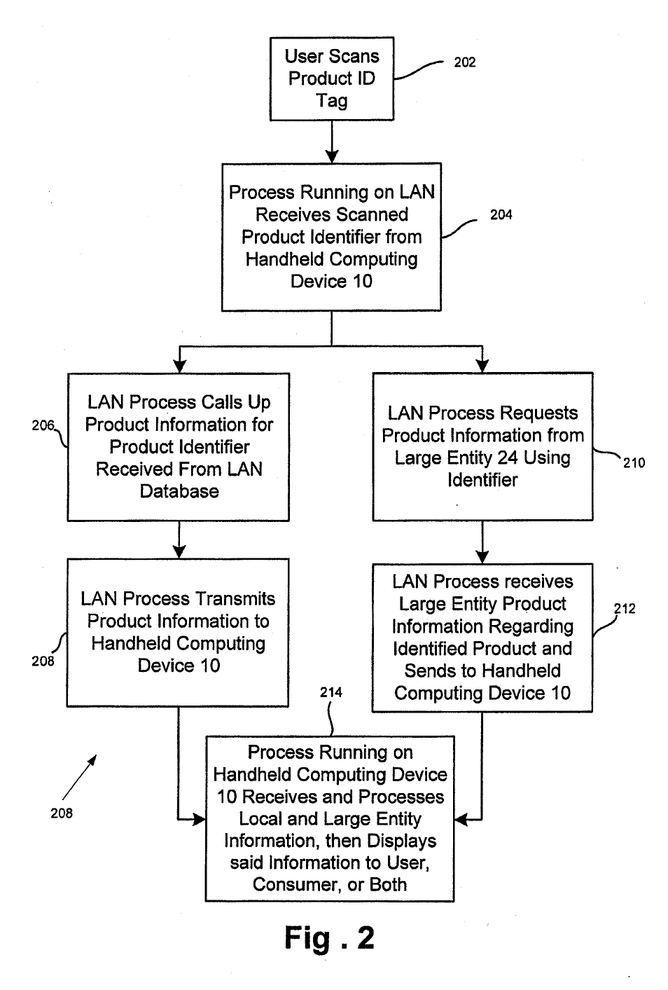

FIG. 1 discloses one environment in which the processes of the present invention may be executed, and FIG. 2 discloses one embodiment for a process which might be executed using the FIG. 1 system.

The FIG. 1 system embodiment comprises at least one handheld portable computing device 10 which is equipped with a reader device. In one embodiment, this reader is a bar-code scanner. Other kinds of reader devices, however, could be used instead. For example, one skilled in the art will recognize that other kinds of product labels or tags can be read using infrared, RFID, or other technologies. It is also contemplated that device 10 will be used along with a number of like devices so that select individual employees (e.g., floor salespersons) can each have one. In one embodiment, each of devices 10 are handheld wireless computing devices. As shown in the figure, although the devices are adapted primarily for use in a local facility 13, it can be seen that one of the devices is depicted as being useable outside the facility. This might be useful, e.g., where products are displayed outside.

In one embodiment, it is expected that portable device 10 will be used within a facility, e.g., a store or other location where different products are identified with some sort of identification tag (e.g., bar codes, RFID). In one embodiment, the facility is a furniture store, and the products being displayed for sale are articles of furniture. Furniture located in retail stores tends to have bar-coded product labels which include a globally-used product identifier. But although furniture stores have been used here as an example, these processes and systems would be useful in numerous facilities and/or locations, and the scope of this invention should not be limited to any particular working environment unless specifically claimed to be.

Device 10, in the FIG. 1 embodiment, includes a display 11 which will be used to present product information to the user, as will be discussed hereinafter. Also in the FIG. 1 embodiment, device 10 is wireless enabled. The wireless arrangement could comprise a WiFi, CDMA, or other kind of wireless networking system. These wireless capabilities enable the device to stay with the user on the floor of the store while obtaining product information using device 10. Where the user is a salesperson, this portability enables the engagement of customers and real-time access to product support information in a facility computer network (e.g., LAN 16), and also from regional, national, global, and/or a manufacturer's databases.

In the FIG. 1 embodiment, portable device 10 is included in a local area wireless network 12. This network can be supported by a wireless router or a wireless access point 14 which is included in a local area network (LAN) 16. Product information regarding various products can be maintained on a PC 18 or some other database 17 also in network 16.

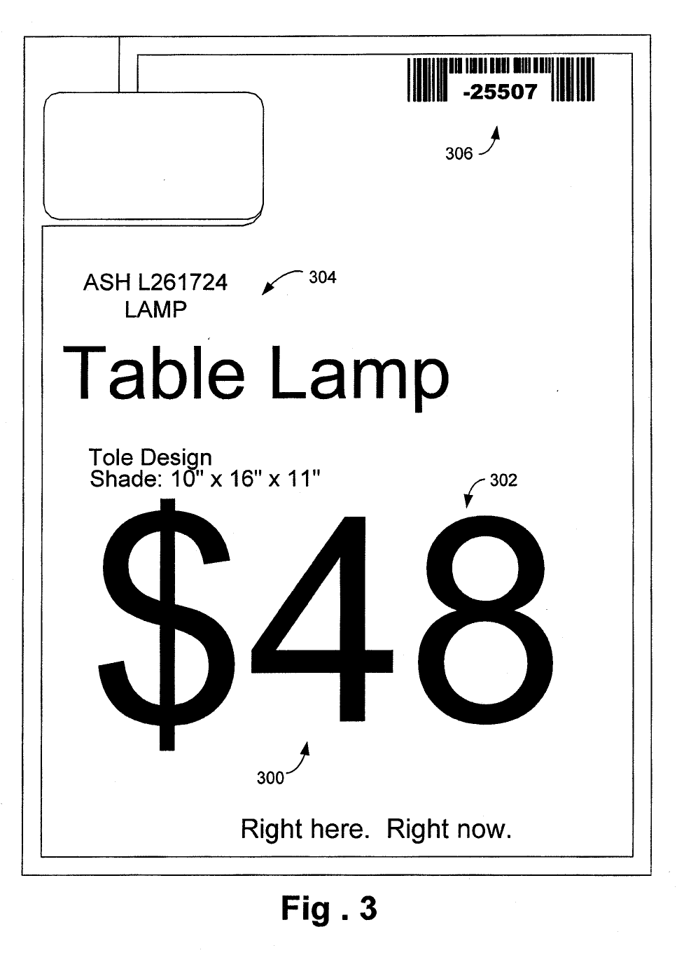

In the network database (e.g., database 17, or a database on PC 18), the products will be identified by some number or other identification means which matches up with readings of that same product taken from the reader mechanism on device 10. For example, for an embodiment where the reader is a bar-code scanner, the bar-code labels on the products in the store would include an identifier which can be matched up with information on the database on PC 18 or database 17 to instantly determine current information regarding that product. In one embodiment, labels like that shown in FIG. 3 might be used. As can be seen from FIG. 3, a label 300 includes a price 302, a product description 304, and a readable bar code identifier 306.

In the FIG. 1 embodiment, product information is also available from a separate entity 24 which sells the product. In the disclosed embodiment, separate entity 24 is a larger entity such as a manufacturer or distributor of the products. For example, the rest of FIG. 1 shows that the device 10, in addition to being supported by the local network 16, can also be supported by a larger entities database 20 over the internet 20 or some other networking scheme. In one embodiment, the larger entity might be a manufacturer of the product where large entity database 20 would have more global product information than available in the local database on LAN 16 (e.g., on PC 18). In another embodiment, large entity 24 might be a furniture manufacturer or distributor which wholesales product to the local furniture retailer discussed above.

The FIG. 1 arrangement has customer support utilities. For example, where the product is unavailable in that locality, it might be useful for the salesman to know whether the product is available at all from the manufacturer, or some other remote locations. Up-to-date global product information (e.g., inventory) is normally readily available on a large entity databases like database 20. Further, this product information is normally stored according to an identifier that enables the products to be matched up with the product identifiers at the local facility. Oftentimes the same identifier is used globally. This makes it possible for the computer processes running on LAN 16 to effectively receive product information from and otherwise exchange product information with large entity 24.

A requirement for enabling these remote support objectives discussed in the last paragraphs will of course require making the LAN 16 processes compatible with the reciprocating processes running computing systems of the large entity. Techniques for incorporating the local and global computing systems, however, will be within the knowledge of those skilled in the art.

One embodiment for system operation is reflected in the flow diagram shown in FIG. 2. Before execution of a FIG. 2 process 200, however, the above described processes, databases, and equipment, will all be in place and prepared for operation as a preliminary measure. Further, the readable product identification tags must be affixed to the products, the reader devices deployed, the LAN database must be set up with the local product information, and the large entity database and support must be built with product identifiers which are the same or relatable.

Once these preliminaries have been completed, process 200 will typically begin when a customer suggests interest in, or asks a question about a particular product in or around a local store. In one embodiment, the requested product information would be the availability of that particular product in the facilities inventory information. This information may include product information from the local facility, other locations, a manufacturer, a global network of product suppliers, or combinations of all of the above. In an embodiment, the local facility 13 is a store which displays products, or model products, in a show room, but has actual inventory located in a local warehouse, or mfg on hand inventory, or mobile inventory. In such cases, the sales person on the floor will probably not know whether or not the product is readily available to the consumer, and would normally have to leave the customer to look up the information on a local hard-wired computer. But in a step 202 of the methods of the disclosed embodiment, the sales person can simply scan the tag on the item using device 10. Because the device 10 is portable, this can all be done in the presence of the consumer in the location of the product.

When scanned, in a step 204, a process running on device 10 receives a signal including the product identifier received, and then communicates this information to a process running on LAN 16. This local process could, e.g., be running on PC 18 or elsewhere in the facility. At that point, process chart 200 splits into two separate tracks.

In a first track, in a step 206, the process running on LAN 16 looks up product information regarding the product using the product identifier received. In one embodiment, the product information regards whether that particular product is available locally in current inventory, e.g., in a storage area in the store, or a local warehouse.

Next, in a step 208, another process running on LAN 16 communicates the local availability or unavailability of the particular product back to the portable device 10. For example, this might involve the process running on LAN 16 makes a determination as to whether request can be satisfied locally (e.g., whether the product is available in warehouse inventory and thus available, or not)

In a second track, in a step 210, a process running on LAN 16 requests product information from database 20 in large entity 24 using the scanned product identifier.

Once this occurs, in a step 212, a process on LAN 16 receives global product information from the large entity database 20 regarding the product identified. Once received, this information is then transmitted back to device 10.

Process 200 is rejoined at a step 214. In step 214, once device 10 receives the local data from LAN 16 transmitted in step 208, and also the global information from database 20 transmitted in step 212, the information selected is presented on display 11 provided on device 10. The combined local and global information would, in one embodiment, include whether the product is available locally, and if not, whether it is available from the manufacturer. The information might also include the dimensions (shipping size, cubes) of the product, product weight, shipping or delivery cost estimates, an estimation of how long it will take to ship the product to the consumer, customer delivery schedules by zip code, on-order product delivery schedules, or price quotes. And all these product determinations received from the local and large entity databases can be immediately shown on display 11 so that the customer can be informed of the product information in real time without the salesman having to leave their side to walk to a computer or other source of information.

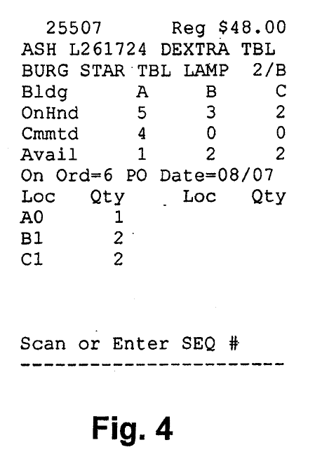

In one embodiment, device 10 is able to interface with the process running on the LAN to optionally receive different kinds of information after the scan which will be displayed. Some screen-shot examples are shown in FIGS. 4-9. The interfacing might occur using function key interfacing, a windows touch screen GUI, or some other known process. A main menu screen for one embodiment of the device 10 is shown in FIG. 4. As can be seen from the figure, the display includes a retail price, a general product description, and inventory information. The inventory information includes the particular building each piece of like-identified product is located in, as well as how many are on hand (“OnHnd”), already committed to another customer (“Cmmtd”), and then how many are actually available for sale (“Avail”). Next, the screen in FIG. 4 shows precise areas within the particular buildings in which the items are located. For example, the single item in building “A” shown in the upper portion of the screen shot is shown to be in locations “A0,” the 2 items in building “B” are located in area “B1” and the item in building “C” is located in location “C1.”

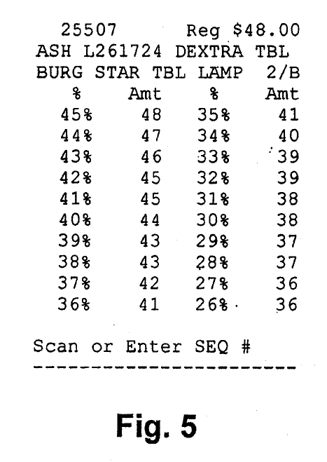

One skilled in the art will recognize that these technologies are useful for numerous purposes. For example, in some embodiments the information received from one of the local or manufacturers databases is retail price wheel information. It is common practice for the retailer, distributor, or manufacturer to maintain up-to-date price point information based on margin. This information is useful to the salesmen. But using the above processes, the salesmen are able to instantly provide current prices to a customer without having to leave to get this information from a book or local computer. Additionally, the salesman can be provided with margin or other valuable pricing information so that a price can be quoted that is competitive and also satisfactory to the retailer. An example screen shot from device 10 showing price information can be seen in FIG. 5. Referring to the figure, it can be seen that in addition to the retail price and a general product description, for a variety of price profit margins shown as percentages (%) a plurality of corresponding prices are shown to help the salesman make accurate and acceptable price quotes immediately after wanding the particular bar code for that product.

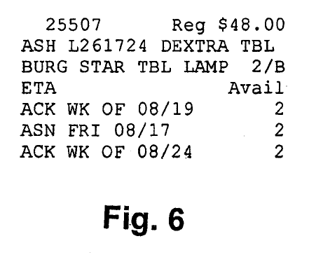

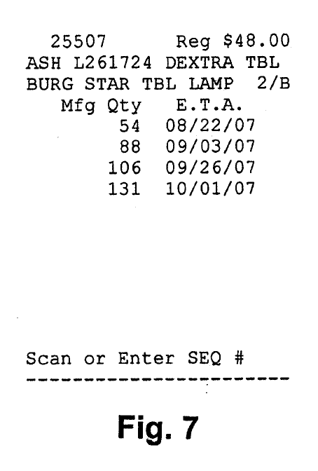

An additional feature is some embodiments is provides order and shipping information. For example, in some embodiments, the process running on LAN 16 is adapted to Acknowledged Order (ACK) and Advanced Ship Notice (ASN) details. The order acknowledgement (ACK) information enables the salesman to see order status, and the ASN information enables the salesman to see notifications by the manufacturer regarding shipment status. Referring to FIGS. 6-7, it can be seen how this information might be displayed upon activation of function keys or other interfacing techniques. Referring to FIG. 6, the user is able (by hitting an appropriate function key) to immediately see current ACK and ASN information. By then accessing (via function keys) the FIG. 7 screen, the user is then able to see exactly how many items are available from the manufacturer (or distributor) and exactly how many of such items are possibly available (“Qty”) and by what dates (“E.T.A.”).

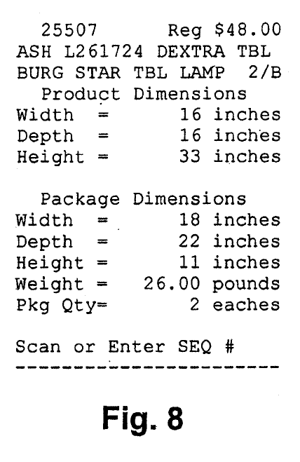

An added feature in some embodiments is that the local application is adapted to include product size specifications (e.g., product height, width, and depth; packaged height, width, and depth; and quantity) and then display this information to the handheld. One embodiment for a display showing this information is shown in FIG. 8. The screen is accessed by function key. These parameters are often useful when a customer is attempting to determine whether a product will fit into a particular location in their dwelling, business, or other place of use.

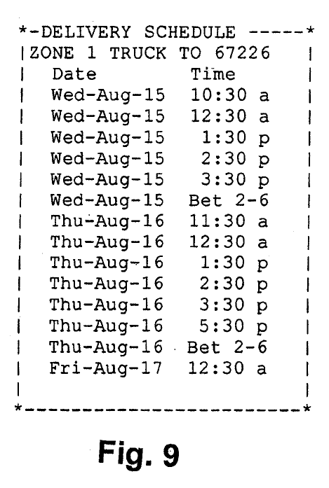

Still another optional feature in some embodiments is a Delivery Time Query process. This process, in one embodiments, enables the receipt of a ZIP code from the handheld. Once the ZIP code is received, it is transmitted to the LAN. Next, a process running on LAN 16 (e.g., on computer 18) determines what delivery times are available. Thus, the salesman is able to tell the customer, while they are still side-by-side at the store, when a purchased item could be delivered to their residence. FIG. 9 shows an embodiment for how this information might be displayed on device 10 showing a number of delivery dates and times.

One skilled in the art will recognize that numerous other kinds of information could be made accessible to the salesman over the handheld device which would benefit the salesman and the customer. It will also be evident that numerous other kinds of query answer arrangements could be utilized.

Because all of the steps in process 200 are executed almost instantly in real time, the user is able to scan a reading from a product tag, and almost instantaneously see both local and global product information on display 11. Continuing with the inventory example, once a customer makes an inquiry as to whether a product is available, the salesman can simply wand the floor model, and receive on display 11 inventory information regarding the product. This prevents the salesman from having to go to a computer terminal, e.g., PC 18, to get the information. Sales are often lost under these circumstances because the delay can cause the customer to change their mind. Further, other shoppers may see the now diverted salesman as available for them, which can further delay the time it takes to get back to the original customer. Using the device 10 along with the disclosed processes avoids this by enabling the salesman to immediately inform the customer of product information while staying with the customer and product. And the salesman can even show the displayed information to the consumer on display 11, if desired. Thus, the customer experiences no detectable delay in learning of the product information, and the salesperson has not been separated from the potential buyer.

It should be noted that after executing the triggering event in step 202 by scanning a product ID tag or label, alternative embodiments could include an additional step in which the user is able to make inquiries. This step, in one embodiment, would occur after step 214. At this point, a product identification has been made by the system, some product information has been supplied to device 10, but other information has not. This additional step gives the user the additional capabilities of receiving even more specific product information than was received in process 200. For example, after the scan calls up the particular product, the user may be given—via some interface on device 10—the ability to make selections or inquiries to receive more information. This interfacing might be done through the use of designated function keys with a supporting application run on device 10.

Alternatively, a windows-type GUI application could be used enabling, i.e., screen interfacing, and keyword searches. In use, for example, considering the furniture embodiment discussed above, the user can request fabric options for a particular sofa. Or instead, the user could receive information relating to what kinds of wood finishes might be available from the manufacturer for a bookshelf. When in response to a customer question, the user salesman can simply obtain the information immediately without leaving the product or customer. Additionally, the information could include price quotes. This information can be derived from either local or the manufacturer's databases.

As is well known in the sale of consumer goods, stores oftentimes do not display or show all of a manufacturer's inventory because of the cost. The floor and/or shelf space required for the actual showing of each product has a very significant cost in terms of overhead to the company. Thus, many stores maintain inventory in a back room, local warehouse, or other location from which the merchandise is available, but not visible to the customer. For example, where a store sells a particular model sofa, only one color may be displayed on the showroom floor, whereas numerous other not shown colors may be available. Because consumers are generally more eager to buy that which they are able to see in the store, these consumers would have to otherwise pick a color without seeing a rendition of the item at all. Using 10, however, the retailer can show the customer pictures, and provide them with other information about the product, even if that particular rendition does not exist on the showroom floor. Thus, the business does not have to stock as many items because even non-stocked items information will show on display 11 with manual ID input. Thus, by using the systems and methods herein, the retail store is not forced to physically display a high percentage of a manufacturer's inventory on the show room floor (or other display area in or about the facility) for the consumer in order for the consumer to have immediate access to information regarding that inventory. This reduces floor space for product display which in turn reduces operating costs.

The information provided from the local database in steps 206 and 208 and/or from the large entity (which will normally be a remote facility, e.g., a manufacturer) in steps 210 and 212 can take many forms, any of which may be of advantage to the salesman depending on the circumstance. For example, the FIG. 1 system is used to enable elaborate interfacing capabilities between the handheld and the LAN 16 (or alternatively or additionally large entity 20) to enable the sales person to build an electronic sales ticket which may be addressed directly at the cashier having to first build and print off a physical ticket at a PC, e.g., PC 18. This electronic ticket will be built by receiving ticket information through the handheld device. This ticket information may include one or more of: (i) the selections made by the customer, (ii) price quotes made with respect to the selections made, and (iii) a unique number provided by the customer (e.g., home phone number) which will be use to identify the ticket. While or after the ticket is electronically built and finalized on the handheld, a data transfer occurs over LAN 16 capturing the information from the handheld and making the electronic ticket available to the cashier at the place of purchase by merely asking the customer for the unique number (e.g., home phone number) earlier supplied to the salesperson. Thus, the cashier is able to receive payment for that ticket in the standard course without any delay.

Multiple tickets may also be generated and maintained at once over the handheld. Additionally, multiple separate tickets can be maintained on separate handheld devices in the store at once. The different tickets may be distinguished by the unique ticket number received from each separate customer. Because multiple tickets are able to be maintained on the handheld at once, the salesman has the advantage of bouncing from customer to customer all the while building separate tickets and not having to go to a PC or printed product information maintained elsewhere. The data transfer and capture capabilities enable the salesman to finalize sales one after the other without having to go to the cashier to instruct, or for any other reason.

The information provided, in embodiments includes up to date pricing information in addition to the margin information already discussed above. More specifically, the information might include sales opportunities for the salesman, e.g., incentives for selling a particular product. The information might also include information relating to current or upcoming sales or promotions.

Another thing provided to the salesman, in embodiments, could include a salesperson snapshot process. This process could be used to keep the salesperson current with respect to where they are in terms of productivity, e.g., numbers of sales, for the day. Another aspect of this process might involve a payroll or other HR related programs in which the salesperson is able to submit working hours or conduct other HR related activities wirelessly, clock-ins, clock-outs, report whereabouts to superiors, without having to leave the side of the customer.

Another advantage to the systems of FIG. 1 and the methods of FIG. 2 is that it enables real-time inventory management. This might include the wireless ordering of inventories. It also might include the execution of inventory cycle count processing.

As can be seen, the present invention and its equivalents are well-adapted to provide a new and useful method for enabling salespersons to market and sell a product, e.g., furniture, without having to leave the side of the potential customer to obtain or convey information. Many different arrangements of the various components depicted, as well as components not shown, are possible without departing from the spirit and scope of the present invention.

The present invention has been described in relation to particular embodiments, which are intended in all respects to be illustrative rather than restrictive. Alternative embodiments will become apparent to those skilled in the art that do not depart from its scope. Many alternative embodiments exist but are not included because of the nature of this invention. A skilled programmer may develop alternative means of implementing the aforementioned improvements without departing from the scope of the present invention.

It will also be understood that certain features and sub combinations are of utility and may be employed without reference to other features and sub combinations and are contemplated within the scope of the claims. Not all steps listed in the various figures need be carried out in the specific order described.

1. A method in a computer system used for the purpose of selling a product, said method including:
providing a product which is labeled with an electronically-readable product identifier;
electronically receiving said product identifier using a handheld computing device;
accessing (i) local product information regarding said product from a local database which is included in a local area network, and (ii) remote product information regarding said product from a remote database;
availing said local product information and said remote product information to said handheld computing device such that said local product information and said remote product information are able to be displayed on said handheld computing device for the purpose of enabling a salesperson to remain with a customer while obtaining said product information.

2. The method of claim 1 wherein said product is an item of furniture.

3. The method of claim 1 comprising:
including said product identifier in a bar code format on or about said product, and
adapting said hand-held computing device to read said bar code format.

4. The method of claim 1 comprising:
including product dimensions in one of said local product information and said remote product information.

5. The method of claim 1 comprising:
including profit margin information in one of said local product information and said remote product information.

6. The method of claim 1 comprising:
including delivery-time estimations in one of said local product information and said remote product information.

7. The method of claim 1 comprising:
including inventory information in said local product information.

8. The method of claim 7 comprising:
including inventory information in said remote product information.

9. The method of claim 7 comprising:
including order status information in one of said local product information and said remote product information.

10. The method of claim 7 comprising:
including estimated delivery time information in one of said local product information and said remote product information.

11. The method of claim 1 comprising:
providing a ticket-building process operable on said handheld computing device, said ticket building process enabling said salesperson to build an electronic ticket, said electronic ticket including at least one product selection made by said customer; and
enabling data-transfer of said electronic ticket to said local area network for payment-management purposes.

12. The method of claim 11 comprising:
causing said product to be added to said electronic ticket by taking a reading from said product identifier on said product.

13. The method of claim 11 comprising:
adapting said ticket building process to enable a plurality of copending electronic tickets on one or both of said handheld or multiple handheld devices simultaneously.

14. The method of claim 11 comprising:
receiving a unique identification number from said customer, and associating said electronic ticket with said unique identification number.

15. The method of claim 14 comprising:
adapting said ticket building process to enable the generation of a second electronic ticket on said handheld computing device;
distinguishing said first ticket from said second ticket using said unique identification number received from said customer, and associating said second electronic ticket with a different identification number received from a second customer.

16. A method of marketing a product using a computing system, said method comprising:
providing at least one employee with a wireless device;
enabling said wireless device with an ability to interface with said computing system from a plurality of locations in a sales area;
using said ability to provide at least one of: (i) product availability information;
(ii) product detail information; (iii) pricing information; and (iv) delivery time forcasting information while remaining in close proximity to both a product and a customer for the purpose of remaining within a close proximity to said customer during a sales attempt.

17. The method of claim 1 comprising:
providing a bar-code reader arrangement for the purpose of enabling a user employee to scan a product and immediately obtain information from both local and remote large entity databases regarding said product.

18. A computer system for use in a furniture store, said system comprising:
providing a plurality of employees of said furniture store with a plurality of wireless devices;
enabling said wireless devices with the ability to interface with a local area network associated with said store from a plurality of locations in a furniture display area in or about said store;
adapting said plurality of wireless devices to receive
(i) product availability information;
(ii) product detail information; and
(iii) pricing information at all of said plurality of locations while also remaining in close proximity to said both said customer and a furniture product on display.

19. The system of claim 18 comprising:
said handheld and said local area network being adapted to include a ticket-building process operable on said handheld computing device, said ticket building process enabling said salesperson to build an electronic ticket, said electronic ticket including at least one product selection made by said customer; and
one of data-transfer and capture means enabling said electronic ticket information to be delivered to said local area network for one of payment management and sales receipt completion purposes.

20. The system of claim 18 comprising:
providing each of said plurality of wireless devices with a bar-code reader which is adapted to read a bar code on a furniture product and then transmit an identifier associated with said bar code to said local area network so that product information can be returned to said wireless computing device regarding said furniture product.
